(19) United States
(12) Patent Application Publication
(10) Pub. No.: US 2007/0075923 A1
(43) Pub. Date: Apr. 5, 2007

(54) Multiple row addressing

(75) Inventors: Rob Anne Beuker, Best (NL); Petrus Maria Greef, Waarle (NL); Ludovicus Marinus Gerardus Maria Tolhuizen, Waarle (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V.

(21) Appl. No.: 10/555,553

(22) PCT Filed: May 10, 2004
(86) PCT No.: PCT/IB04/01481

§ 371 Date: Sep. 7, 2006

(30) Foreign Application Priority Data
May 12, 2003 (EP) 0310132.1

(51) Int. Cl. G09G 3/20

(52) U.S. Cl. 345/55

(57) ABSTRACT

A passive-matrix display device has rows (2) of pixels (Pij). A row driver (8) selects sub-groups of the rows (2) to obtain multiple row addressing. Each sub-group has a particular number (p) of the rows (2). In each frame period (Tf) the sub-groups are selected a number of times equal to the particular number (p) at different select instants (ti). The multiple row addressing is based on a scheme defined by a function matrix (FM) which has orthogonal functions (Fi(t)). The columns of the function matrix (FM) represent the orthogonal functions (Fi(t)) at the select instants (ti). The function matrix (FM) is changed such that each one of the columns has at least two non-zero elements (−1,1) and at least one zero element (0).

The invention relates to a passive-matrix display device with multiple row addressing, a display apparatus comprising a passive-matrix display device, and a method of multiple row addressing in a passive-matrix display device.

Passive-matrix displays are generally known. For realizing a high number of display lines (also referred to as rows), these displays are increasingly based on the STN (Super-Twisted Nematic) effect. WO-A-01/61678 discloses a matrix display device with multiple row addressing (further referred to as MRA). In MRA, a (sub)-group of p rows is driven with mutual orthogonal signals. Since a set of orthogonal signals, such as Walsh functions, consists of a plurality of functions which is a power of 2, i.e. 2^{s}, p is preferably selected to be equal thereto as much as possible, i.e., generally, p=2^{s} (or p=2^{s}−1). The orthogonal row signals are preferably square wave shaped and consists of voltages +F and −F during the selection period during which a row of pixels is selected or addressed, while the row voltage is equal to zero outside the selection period. The voltage pulses, from which the orthogonal signals are built up, are preferably regularly distributed across the frame period. In this manner, the pixels are exited p times per frame period with regular intermissions instead of once per frame period. Even for low values of p, such as p=3, 4, 7 or 8, the frame response appears to be suppressed just as satisfactory as when driving all the rows simultaneously.

The column or data signals to be supply to the selected groups of rows is defined by
Gj(t)=cΣFi(dtk)*Iij(t)
wherein t is the time, i, j and k are indices, c is a constant, Fi(dtk) are the orthogonal row signals, further referred to as the row signals, dtk indicates that the row signals Fi(dtk) have a fixed value during a sub-period of the frame period such that all the groups are p times selected with the same p combinations of the row signals, Iij(t) is the information defining the optical state of the pixel in row i and column j, and the sum is calculated for all the simultaneously selected rows of the group. The pixel information Iij(t) is defined by the value −1 or +1 as only on (white) or off (black) has to be coded.

For example, if four rows i1 to i4 are selected simultaneously, the column signal for the column j is for the first time these rows are selected:
Gj(t1)=c(F1(dt1)×Ii1j(t1)+F2(dt1)×Ii2j(t1)+F3(dt1)×Ii3j(t1)+F4(dt1)×Ii4j(t1)).

Because four rows are selected simultaneously, the groups of four rows will be selected four times in the frame period.

The second time the rows are selected the column signal will be:
Gj(t2)=c(F1(dt2)×Ii1j(t2)+F2(dt2)×Ii2j(t2)+F3(dt2)×Ii3j(t2)+F4(dt2)33 Ii4j(t2)).

It is thus possible to define the MRA by a function matrix M in which the columns are the row signals Fi(dtk) (thus, in the example of four simultaneously selected rows: F1(dtk), F2(dtk), F3(dtk), F4(dtk)) with dtk ranging from dt1 to dt4.

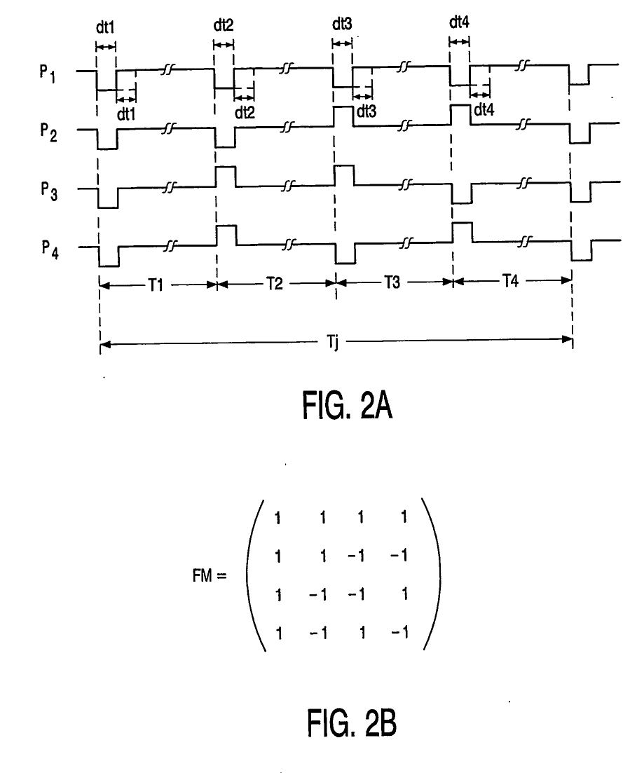

Thus, ti is the particular instant a group of four rows is addressed in the sequence of four addressing instants during a frame, and dtk indicates one of the four addressing periods in the frame period (see also FIG. 2).

To conclude, in the example of four simultaneously selected rows, the function matrix will have four columns representing the four instants of addressing of the particular group, and four rows representing the orthogonal functions Fi(dtk):

$$M = [ \begin{matrix}F 1 ( dt 1 ) & F 1 ( dt 2 ) & F 1 ( dt 3 ) & F 1 ( dt 4 ) \\ F 2 ( dt 1 ) & F 2 ( dt 2 ) & F 2 ( dt 3 ) & F 2 ( dt 4 ) \\ F 3 ( dt 1 ) & F 3 ( dt 2 ) & F 3 ( dt 3 ) & F 3 ( dt 4 ) \\ F 4 ( dt 1 ) & F 4 ( dt 2 ) & F 4 ( dt 3 ) & F 4 ( dt 4 )\end{matrix} ]$$

The orthogonal row signals Fi(dkt) only may have three values: zero if the row is not selected, the positive voltage +F or the negative voltage −F if the row is selected. Usually, the positive value is indicated by a +1, the negative value is indicated by a −1 and the zero is indicated by a 0.

A well known function matrix defining a MRA scheme is the N=4 Hadamard matrix:

$$H4 = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$$

The number of column voltages which the column signals Gj have to be able to supply is equal to one plus the number of entries in the columns, thus, number of rows of a group plus 1. In the example of the H4 matrix, the column driver should be able to generate 5 levels: −4F, −2F, 0, 2F and 4F.

This relatively high number of required different column or data voltages limits the power efficiency of the (integrated) circuit which performs the MRA scheme.

It is an object of the invention to reduce the number of different data voltages required without increasing the number of addressing cycles.

A first aspect of the invention provides a passive-matrix display device comprising: rows of pixels, and a row driver for selecting sub-groups of the rows to obtain multiple row addressing, the sub-groups comprising a particular number of the rows, in each frame period the sub-groups being selected a number of times equal to the particular number at respective different select instants, the multiple row addressing being based on a scheme defined by a function matrix comprising orthogonal functions, columns of the function matrix representing the orthogonal functions at the select instants, wherein in each one of the columns at least two non-zero elements and at least one zero element is present.

A second aspect of the invention provides a display apparatus comprising the passive-matrix display device.

A third aspect of the invention provides a method of multiple row addressing in a passive-matrix display device with rows of pixels, the method comprising selecting sub-groups of the rows to obtain multiple row addressing, the sub-groups comprising a particular number of the rows, in each frame period the sub-groups being selected a number of times equal to the particular number at respective different select instants, the multiple row addressing being based on a scheme defined by a function matrix comprising orthogonal functions, columns of the function matrix representing the orthogonal functions at the select instants, wherein in each one of the columns at least two non-zero elements and at least one zero element is present.

Advantageous embodiments are defined in the dependent claims.

In accordance with the first aspect of the invention, instead of the known function matrix which comprises only +1 and −1 elements, a new function matrix is used which is orthogonal and in which in each column at least two non-zero elements and at least one zero element is present.

If each column comprises one zero element, the data signal will require one level less. For example in a four by four matrix with a single zero in each column, the data signal is a summation of three +F or −F values and thus only the four voltage levels −3F, −F, F, 3F are required instead of the five levels usually required if a four by four matrix is used. More zeros per column lead to even less levels.

In an embodiment, the function matrix is a conference matrix which comprises the elements {−1, 0, 1} only, and which has the property that the diagonal elements are zero and the off-diagonal elements are non-zero. These conference matrixes, which as such are well known in the art, enable addressing the matrix display with a same number of total scans while the column driver has to generate one voltage level less. The total number of scans is the number p which indicates the number of times each sub-group is addressed in a frame period multiplied by the number of sub-groups which is the total number of rows divided by the number p which also indicates the number of rows in each sub-group of rows.

Preferred embodiments are defined of conference matrices.

In another embodiment, the function matrix is a combination of smaller orthogonal matrices.

These and other aspects of the invention are apparent from and will be elucidated with reference to the embodiments described hereinafter.

In the drawings:

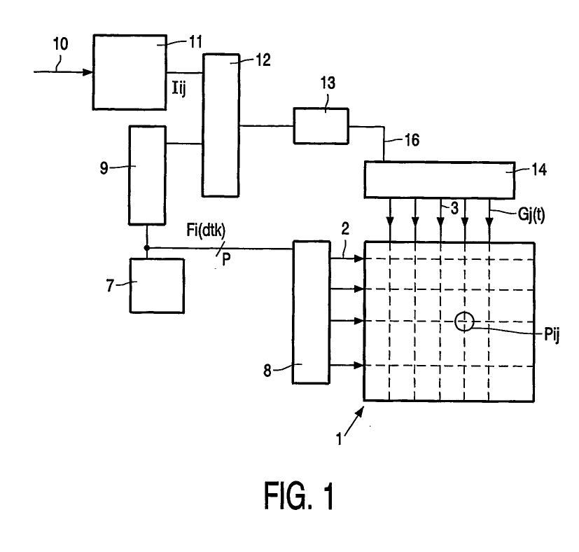

FIG. 1 shows a known display apparatus which comprises a passive matrix display which is driven in a multiple row addressing mode,

FIG. 2 shows an embodiment of known row selection pulses and a corresponding function matrix determining the multiple row addressing mode, and

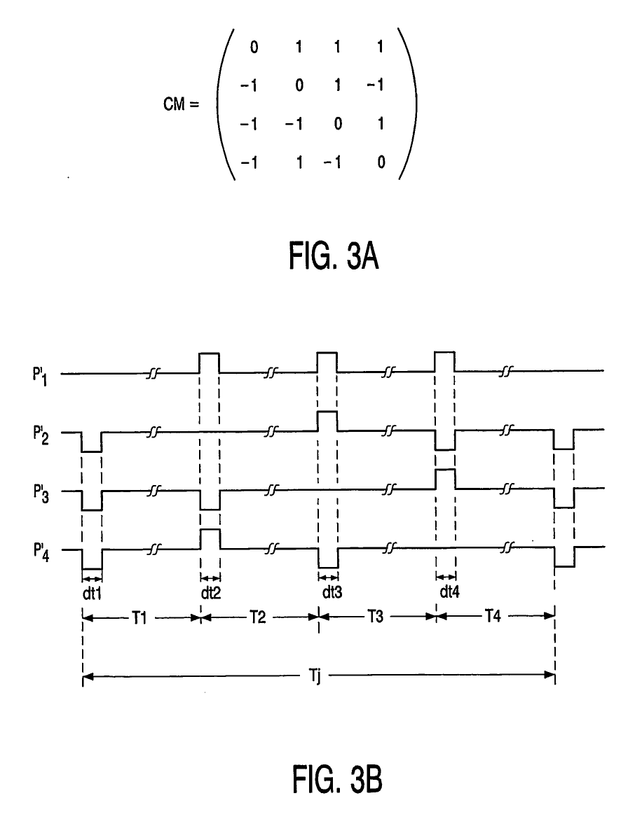

FIG. 3 shows a function matrix and row pulses in accordance with a preferred embodiment of the invention.

FIG. 1 shows a known display apparatus which comprises a passive matrix display which is driven in a multiple row addressing mode. The display device comprises a matrix 1 of pixels Pij associated with intersections of crossing row electrodes 2 and column electrodes 3. The display may be transposed in that the rows and columns are interchanged. Therefore, the row electrodes 2, and the column electrodes 3 are more generally referred to as select electrodes 2 and data electrodes 3. The row electrodes 2 and the column electrodes 3 are provided on facing surfaces of substrates (not shown) sandwiching the liquid crystal material (not shown). Other elements may be present, such as orientation layers, polarizers, etc. (not shown).

The display apparatus further comprises a row function generator further referred to as function generator 7 which generates the orthogonal functions Fi(dtk) to be supplied to the row electrodes 2. The function generator 7 may be a ROM in which the orthogonal functions Fi(dtk) are stored for retrieval. As disclosed in WO-A-01/61678, row vectors which are defined for each elementary time interval drive a group of p rows via the row driver 8. The row vectors are stored into a row function register 9. The row vectors comprise the orthogonal functions Fi(dtk) for one of the p addressing instants during a frame of the groups of rows. Thus p sets (the vectors) of orthogonal functions Fi(dtk) are defined, each one for one of the elementary time intervals which are related to the p addressing periods during a frame. In distributed MRA, the same vectors are applied on subsequently selected sub-groups of rows until all rows have been selected. This is repeated p times such that all sub-groups are addressed p times. The time period required to select all sub-groups such that all rows are selected once is called the elementary time interval. The p addressing periods refer to the periods in time which are separated by the elementary time interval and during which the same sub-group is selected. The same vectors are used during a particular one of the elementary time intervals, the different vectors are used one at a time during the addressing periods.

Information 10 to be displayed is stored in a p×M buffer memory 11 and read as information vectors per elementary time unit. The information vectors comprise the pixel information Iij. The elementary time unit is the period in time a sub-group of rows is addressed. The signals Gj(t) for the column electrodes 3 are obtained by multiplying the then valid values of the row vector and the information vector during each elementary time unit and by subsequently adding the p obtained products. The multiplication of the values of the row vector and the information vectors which both are valid during an elementary time unit is realized by comparing them in an array 12 of M exclusive ORs. The addition of the products is effected by applying the outputs of the array of exclusive ORs to the summing logic 13. The signals 16 from the summing logic 13 drive a column drive circuit 14 which provides the column electrodes 3 with the voltages Gj(t) having p+1 possible voltage levels. Every time, p rows are driven simultaneously, in which p<N, N is the total number of rows. The row vectors therefore only have p elements, as well as the information vectors.

FIG. 2 shows an embodiment of known row selection pulses and a corresponding function matrix determining the multiple row addressing mode. FIG. 2A shows an example of pulse patterns derived from an orthogonal function matrix shown in FIG. 2B for the purpose of multiple row addressing with p=4.

In FIG. 2A, four pulse trains P1 to P4 are shown, the pulse train P1 is supplied to a first row of a particular sub-group of four rows, the pulse train P2 is supplied to a second row of the particular sub-group of four rows, the pulse train P3 is supplied to a third row of the particular sub-group of four rows, and the pulse train P4 is supplied to a fourth row of the particular sub-group of four rows. The elementary time units which are the time periods during which the particular sub-group of rows is selected are indicated by dt1 to dt4. The elementary time interval which is the period in time during which all the rows are addressed once by using the same orthogonal set of four functions Fi(dtk), are indicated by T1 to T4. Tf indicates the frame period.

The polarity of the pulses occurring during the elementary time units dt1 to dt4 is determined by the function matrix shown in FIG. 2B. A 1 in the function matrix is a negative going pulse, a −1 in the function matrix is a positive going pulse.

The orthogonal functions Fi(dtk) are determined by the function matrix in that the first row of the function matrix provides F1(dt1) to F1(dt4), the second row provides F2(dt1) to F2(dt4), the third row provides F3(dt1) to F3(dt4), and the last row provides F4(dt1) to F4(dt4).

The next group of four rows is addressed in the same manner during elementary time units td1′ to td4′ succeeding the elementary time units td1 to td4, respectively.

By way of example only, to elucidate the number of total scans which is required within a frame period Tf, a display which has 132 rows is considered. If a four by four matrix is used, thus p=4, four rows are selected simultaneously. During the frame period Tf, all the rows are selected four times, thus the number of MRA scans is four. The number of scans required to scan all the rows once is 132/4, thus, the number of address scans=33. The total number of scans is the number of address scans multiplied by the number of MRA scans, thus the total number of scans is 4×33=132.

It is to be noted that if one row of the function matrix is omitted, the total number of scans increases. For example, if in the example above, a three by four matrix is used, the number of MRA scans stays 4 because the column voltages are determined four times during four elementary time units. However, the number of address scans has to increase with a factor 4/3 as only three instead of four rows are selected simultaneously. Consequently, the total number of scans will become 176=4×44.

FIG. 3 shows a function matrix in accordance with a preferred embodiment of the invention. The number of voltage levels to be generated by the data driver 14 is reduced by introducing a zero element in each of the columns of the function matrix. The resulting matrix should remain orthogonal.

In a preferred embodiment in accordance with the invention, the function matrix is a so-called conference matrix which has elements −1, 0, 1 only, the zero elements being positioned on a diagonal of the matrix, the off-diagonal elements being −1 or 1.

FIG. 3A shows an example of a 4×4 conference matrix and FIG. 3B the resulting row pulses P1′ to P4′. Now, a positive going pulse is related to a 1 in the function matrix, a negative going pulse is related to a −1 in the function matrix, and no pulse corresponds to a zero in the matrix. The references in FIG. 3 which are the same as the references in FIG. 2 have the same meaning.

Other examples of conference matrixes are:

$$CM = [ \begin{matrix}0 & 1 & 1 & 1 & 1 & 1 \\ 1 & 0 & 1 & - 1 & - 1 & 1 \\ 1 & 1 & 0 & 1 & - 1 & - 1 \\ 1 & - 1 & 1 & 0 & 1 & - 1 \\ 1 & - 1 & - 1 & 1 & 0 & 1 \\ 1 & 1 & - 1 & - 1 & 1 & 0\end{matrix} ]$$

$$CM = [ \begin{matrix}1 & 1 & 1 & 1 & 0 & 0 \\ 1 & 1 & - 1 & - 1 & 0 & 0 \\ 1 & - 1 & 0 & 0 & 1 & 1 \\ 1 & - 1 & 0 & 0 & - 1 & - 1 \\ 0 & 0 & 1 & - 1 & 1 & - 1 \\ 0 & 0 & 1 & - 1 & - 1 & 1\end{matrix} ]$$

Alternatively, it is possible to use a function matrix which is a combination of orthogonal matrices of which the elements do not overlap and of which the elements not covered by the orthogonal matrices are zero. An example of such a combination function matrix is:

$$F = [ \begin{matrix}1 & 1 & 1 & 1 & 0 & 0 \\ 1 & - 1 & 1 & - 1 & 0 & 0 \\ 1 & 1 & - 1 & - 1 & 0 & 0 \\ 1 & - 1 & - 1 & 1 & 0 & 0 \\ 0 & 0 & 0 & 0 & 1 & 1 \\ 0 & 0 & 0 & 0 & 1 & - 1\end{matrix} ]$$

It is clear that many more orthogonal matrices with at least one zero in each column are possible. The row pulses can easily be deduced from the elements in the matrix as shown in FIGS. 2 and 3. The column signals can be calculated with the equation
Gj(t)=cΣFi(dtk)*Iij(t).

The introduction of the zeros in the function matrix does not give rise to an increased total number of scans. As discussed earlier with respect to the example of a display which has 132 rows, the total number of scans for a four by four prior art function matrix, which does not comprise any zeros, is 132. In a four by four function matrix in accordance with an embodiment of the invention in which one zero is present in each column, both the number of MRA scans stays 4 (the function matrix has still 4 columns) and the number of address scans stays 33 (the function matrix has still 4 rows) and thus, the total number of scans stays 132.

In principle, the number of the row voltages has to increase by one because of the zero which is introduced in the function matrix. In practice, the zero voltage is already used for not addressed rows, thus no extra effort is required to supply a zero voltage to the rows. The decrease of the number of column voltages is however relevant as this costs a switch less per column. Further, the maximum voltage level required to be supplied by the column driver 14 becomes lower. For example, if the prior art four by four function matrix is adapted to comprise a single zero per column, the maximum column voltage required is 3F instead of 4F.

It should be noted that the above-mentioned embodiments illustrate rather than limit the invention, and that those skilled in the art will be able to design many alternative embodiments without departing from the scope of the appended claims. For example, it is possible to exchange rows and/or columns in the matrices.

In the claims, any reference signs placed between parentheses shall not be construed as limiting the claim. The word “comprising” does not exclude the presence of other elements or steps than those listed in a claim. The invention can be implemented by means of hardware comprising several distinct elements, and by means of a suitably programmed computer. In the device claim enumerating several means, several of these means can be embodied by one and the same item of hardware.

1. A passive-matrix display device comprising:
rows of pixels, and
a row driver for selecting sub-groups of the rows to obtain multiple row addressing, the sub-groups comprising a particular number of the rows, in each frame period the sub-groups being selected a number of times equal to the particular number at respective different select instants, the multiple row addressing being based on a scheme defined by a function matrix comprising orthogonal functions, columns of the function matrix representing the orthogonal functions at the select instants, wherein in each one of the columns at least two non-zero elements and at least one zero element is present.

2. A passive-matrix display device as claimed in claim 1, wherein the function matrix is a conference matrix.

3. A passive-matrix display device as claimed in claim 2, wherein the conference matrix is defined by
$$CM = [ \begin{matrix}0 & 1 & 1 & 1 \\ - 1 & 0 & 1 & - 1 \\ - 1 & - 1 & 0 & 1 \\ - 1 & 1 & - 1 & 0\end{matrix} ]$$

4. A passive-matrix display device as claimed in claim 2, wherein the conference matrix is defined by
$$CM = [ \begin{matrix}0 & 1 & 1 & 1 & 1 & 1 \\ 1 & 0 & 1 & - 1 & - 1 & 1 \\ 1 & 1 & 0 & 1 & - 1 & - 1 \\ 1 & - 1 & 1 & 0 & 1 & - 1 \\ 1 & - 1 & - 1 & 1 & 0 & 1 \\ 1 & 1 & - 1 & - 1 & 1 & 0\end{matrix} ]$$

5. A passive-matrix display device as claimed in claim 2, wherein the function matrix is defined by
$$CM = [ \begin{matrix}1 & 1 & 1 & 1 & 0 & 0 \\ 1 & 1 & - 1 & - 1 & 0 & 0 \\ 1 & - 1 & 0 & 0 & 1 & 1 \\ 1 & - 1 & 0 & 0 & - 1 & - 1 \\ 0 & 0 & 1 & - 1 & 1 & - 1 \\ 0 & 0 & 1 & - 1 & - 1 & 1\end{matrix} ]$$

6. A passive-matrix display device as claimed in claim 1, wherein the function matrix is a combination of non-overlapping smaller orthogonal matrixes, elements of the matrix not defined by elements of the orthogonal matrixes being zero.

7. A passive-matrix display device as claimed in claim 6, wherein the function matrix is defined by
$$FM = [ \begin{matrix}1 & 1 & 1 & 1 & 0 & 0 \\ 1 & - 1 & 1 & - 1 & 0 & 0 \\ 1 & 1 & - 1 & - 1 & 0 & 0 \\ 1 & - 1 & - 1 & 1 & 0 & 0 \\ 0 & 0 & 0 & 0 & 1 & 1 \\ 0 & 0 & 0 & 0 & 1 & - 1\end{matrix} ]$$

8. A display apparatus comprising the passive-matrix display device as claimed in claim 1.

9. A method of multiple row addressing in a passive-matrix display device with rows of pixels, the method comprising
selecting sub-groups of the rows to obtain multiple row addressing, the sub-groups comprising a particular number of the rows, in each frame period the sub-groups being selected a number of times equal to the particular number at respective different select instants, the multiple row addressing being based on a scheme defined by a function matrix comprising orthogonal functions, columns of the function matrix representing the orthogonal functions at the select instants, wherein in each one of the columns at least two non-zero elements and at least one zero element (0) is present.
